(19) United States
(12) Patent Application Publication
(10) Pub. No.: US 2021/0221578 A1
(43) Pub. Date: Jul. 22, 2021

(54) INTEGRATED BEVERAGE CAN END INFUSION PORT AND METHOD OF USE

(71) Applicant: Pegasus Holdings LLC, Lakewood, CO (US)

(72) Inventor: Daniel Griffin, Littleton, CO (US)

(73) Assignee: Pegasus Holdings LLC, Lakewood, CO (US)

(21) Appl. No.: 17/150,769

(22) Filed: Jan. 15, 2021

Related U.S. Application Data
(60) Provisional application No. 62/962,753, filed on Jan. 17, 2020.

(51) Int. Cl. B65D 51/00; B65D 17/00; B65D 17/28; A23L 2/52

(52) U.S. Cl. CPC B65D 51/002; B65D 17/02; A23V 2002/00; A23L 2/52; B65D 17/4012

(57) ABSTRACT

There is provided an infusion port for a beverage can and more specifically, an infusion port that is integrated within a beverage can end and a method of infusion.

The following discloses an infusion port for a beverage can and more specifically, an infusion port that is integrated within a beverage can end and a method of infusion.

### BACKGROUND

Caps used with liquid containers in which withdrawal of a medicine or substance can be achieved without removing the cap are common in the industry. Pierceable septa are generally used for dispensing medication using a syringe to withdraw the medicine where a reliably sealed container is required. Generally, the cap is made up of a resilient material that allows removal of the contents of a medicinal container without breaching the sterility of the container. Further, due to the resilient nature of the cap material, a seal will form around the needle as it penetrates the cap and a partial vacuum will be formed within the container as liquid is withdrawn into the needle. Once the needle is withdrawn, the septum automatically reseals, maintaining a reliable seal. This type of septum is commonly used to withdraw medicine from sterile containers.

There is a need for an infusion system in the beverage industry whereby a sealed beverage container may be accessed after purchase or after shipping to infuse the beverage with the infusant of choice. There is provided a beverage container can end containing a pierceable septum that permits injection or infusion of substances into a beverage container without removing the container can end or opening the can and impacting carbonation.

### DRAWINGS

FIG. 1 is a perspective view of a beverage can and can end with integrated infusion port;

FIG. 2 is a top view of FIG. 1;

FIG. 3 is a top view of FIG. 1;

FIG. 4 is a side view of FIG. 1;

FIG. 5 is a cross-section view about lines 4-4 of FIG. 3;

FIG. 6 is a perspective view of the infusion port of FIG. 1;

FIG. 7 is a side view of FIG. 6;

FIG. 8 is a perspective view of FIG. 1 showing use;

FIG. 9 is a perspective view of an alternate form of infusion port;

FIG. 10 is a top plan view of FIG. 9;

FIG. 11 is a side view of a bottle cap with an integrated form of infusion port;

FIG. 12 is a top plan view of FIG. 11;

FIG. 13 is a side view of the infusion port of FIG. 11 and

FIG. 14 is a bottom view of FIG. 12.

### DESCRIPTION

The following describes an infusion system in a single serve or multi-serve beverage container for imparting flavor, herbs, supplements into beverages such as beer or non-alcoholic beverages.

There is provided a beverage container having a can body 15 defined by a cylindrical sidewall 11 including a closed bottom wall integrally formed with the sidewall 11. The sidewall 11 is tapered at both upper and lower ends to provide greater structural integrity for pressurized contents. The can body 15 is generally a conventional drawn and ironed aluminum alloy can body that is commercially used for carbonated and other beverages. Steel may also be used for the can body, such as is common in Europe. The manufacture of the can body is well known in the prior art. The can body 15 has an open upper end 13 with a circular top edge 17 that is oriented in a plane perpendicular to the vertical axis of the sidewall 11. The can body 15 may be a single serve can or larger size to accommodate a larger volume of beverage. The can body is pre-filled with the chosen beverage prior to placement of a can end.

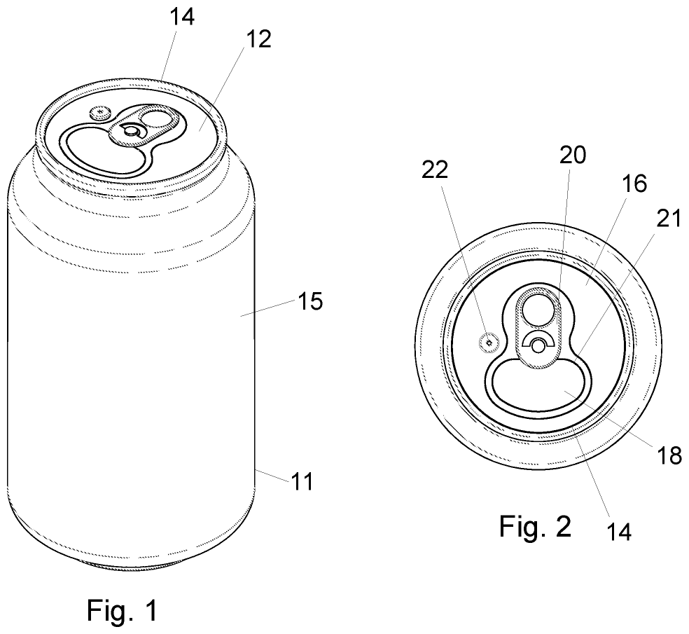

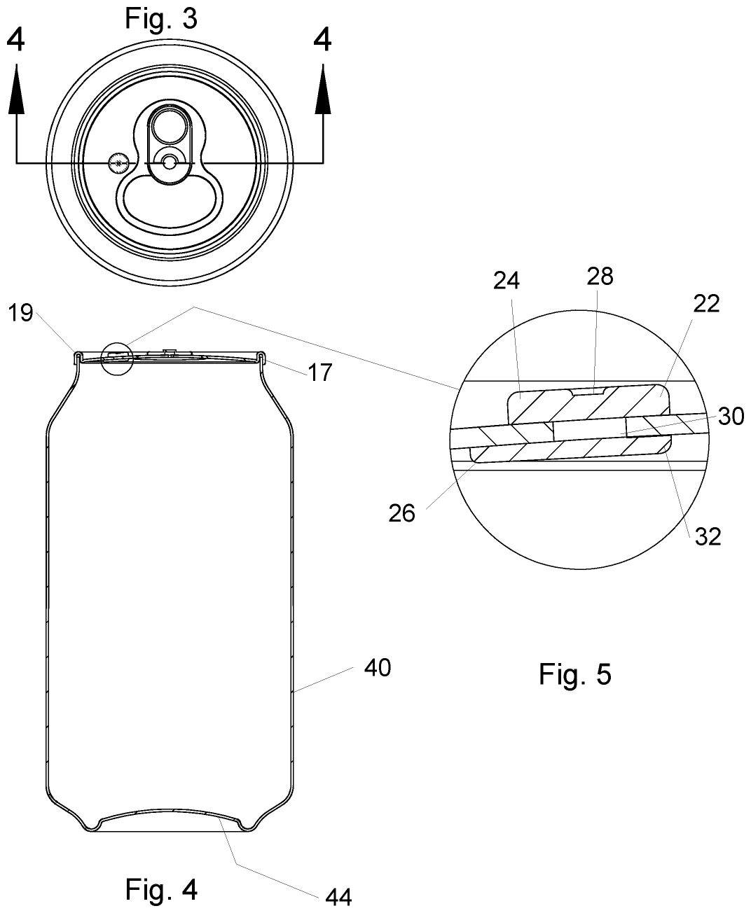

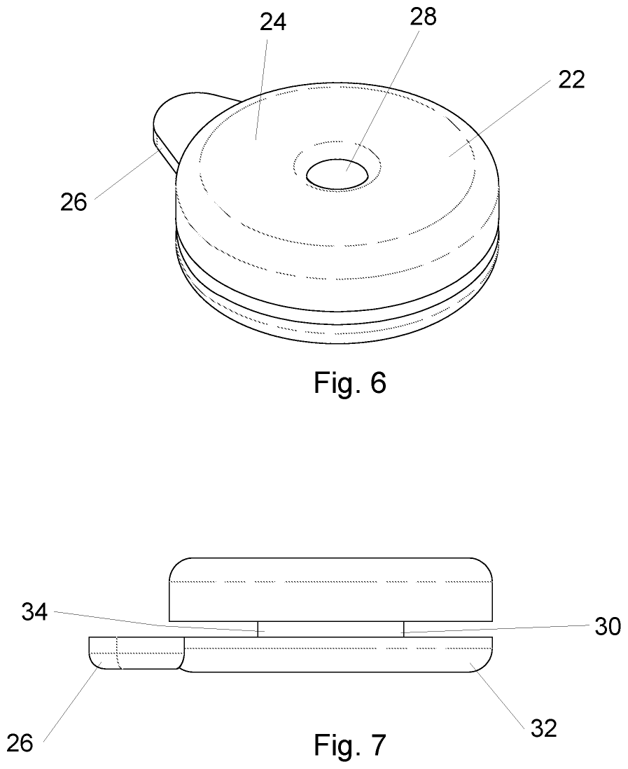

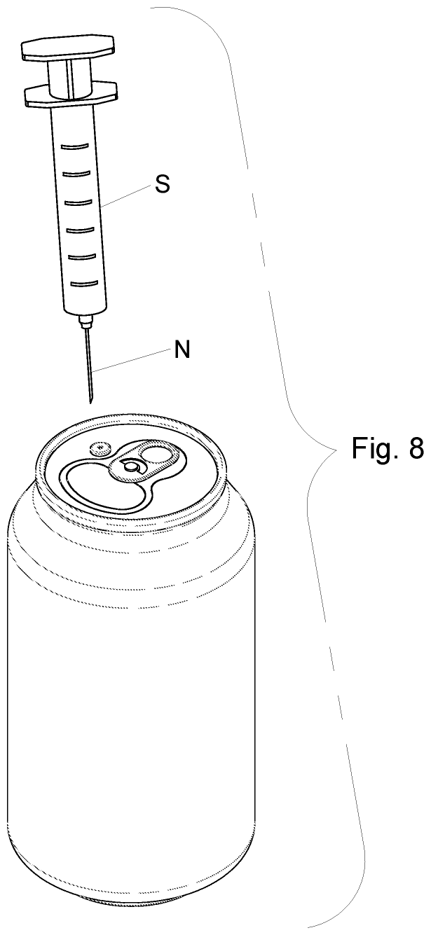

A beverage can end 12 has a concentric shape with a circular periphery around which is formed a raised annular rim 14 projecting upwardly above a flat surface 16. Except as previously described, the can end 12 of the can 40 of FIG. 1 is also a generally conventional aluminum alloy can end member of the type currently commercially used for beverage cans having drawn and ironed one-piece can bodies. Thus, the procedures, and its general overall configuration as well as the manner in which it is secured to the top edge 17 of the can body 15, are all well-known in the art.

Once the can end 12 is mounted on the open upper end 13 of the beverage-filled can body 15, in a known manner, the rim 14 engages an upper edge 17 of the can body along a continuous annular double seam 19. The circular flat surface 16 lies substantially in a horizontal plane. The can end 12 has a scored opening 18 through which the beverage contained in the can may be poured or removed by drinking directly from the can or with a straw. Generally, and well known in the prior art, the scored opening 18 has a centrally located scored portion 21 on the metal of the can end 12 and a riveted pull tab system 20 for parting the can end metal along the score line 12 to open the first aperture 18.

The can end 12 includes an infusion port opening 34 that is punched through the can end and is defined by a circular opening that is formed near a peripheral edge of the can end 12. The diameter of the port opening is in the range of 3/16 to ⅛ inches and is designed to receive an infusion septum 22. The infusion septum 22 has an upper collar 24 that is defined by a circular shaped outwardly extending member having edges 25, a locator or infusion port 28 that is centrally located along the upper surface of the upper collar 24 forming a circular indentation or recessed portion and having a reduced thickness in comparison with the upper collar 24. The locator port is aligned over the port opening 34.

A gate member 30 forms a bridge between the upper collar 24 at the locator port, the port opening 34 and a base member 32 with a tab member 26. The gate member provides a path or conveyor for a piercing member to pass through the port opening 34. The base member 32 also forms part of the septum 22 and is secured to a lower surface 37 of the can end 12 by means of overmolding to be described in more detail, and to the gate member 30. The base member 32 is also defined by a circular shaped outwardly extending member having edges 39 and a lower portion of the base member 32 is in fluid communication with the contents of the beverage can. The upper collar 24 with the locator port 28 is centered over the port opening 34 with a gate member 30 between the upper collar 24 and the base member 32 to provide a pierceable sealing member to allow for infusion. The locator port 28, the gate member 30 and the base member are all designed to be penetrated by a piercing member such as a needle and capable of resealing.

The infusion septum 22 is preferably made of a molded resilient plastic material such as polyethylene, vulcanized rubber, silicone, elastomers of any kind, thermoplastic elastomer (TPE) with a durometer or shore hardness rating between 35 A to 80 A, but preferably 35 A to 50 A. This is generally medical grade self-sealing rubber that is easily penetrable by needles ensuring a leak free seal without fragmentation after penetration and self-sealing.

The formation of the port opening 34 in the can end 12 is accomplished by first using a mechanical/pneumatic punch press and creating an opening that is approximately 0.125 inches in diameter. This is a preferable dimension but other dimensions may be used without departing from the scope. Another method is to form the opening within the injection mold with a moveable punch pin and vacuum to remove any waste material. The punch pin method is preferable as it allows for precise hole placement to insure a centered infusion port.

The infusion septum 22 may be formed with injection overmolding of the elastomer. The port may also be manufactured using compression molding and liquid silicone injection molding (LIM). Further, the port may also be formed using a two piece ultrasonically welded unit. The over-molding of the upper collar 24, the gate member 30 and the base member 32 are preferably completed in one process with the gate member 30 injected through the lower surface 37 of the can end 12. The molding process may occur with the gate member 30 being injected from the top surface or lower surface 37 of the can end 12 without departing from the scope. Further, a two-step process may be used where the gate member 30 and either the upper collar 24 or base member 32 are created first, the product is cooled and then the infusion septum is finished with the addition of either the upper collar 24 or the base member 32 to complete the process.

In use, the can body 15 is filled with a pre-determined volume of chosen beverage. Generally, the can is filled just below the surface edge 17 of the can body. The beverage may be carbonated or non-carbonated, alcoholic or non-alcoholic. The can body 15 is then sealed with the can end 12 having the integrated infusion septum as previously described, and the product is prepared for shipping. Once the product arrives at the desired destination, the can body 15 and can end 12 with the pre-filled beverage are placed on an assembly line for infusion. The beverage contained within the can body 15 may be infused prior to shipping or after shipping, as desired.

The method of infusion involves placement of the pre-filled and sealed beverage container having an integrated infusion port on a flat surface. A dispensing member, preferably a syringe with a piercing member, preferably a 21 gauge needle, is filled with the desired infusant. This may consist of herbal supplements, vitamins, flavorants, colorants etc. to impart health benefits or desired flavors or colors to a pre-filled beverage can. The needle may also have a different gauge depending upon the viscosity of the infusant. The infusion port 28 is normally sealed with respect to the atmosphere and is opened with the use of the needle N to disperse the infusant into the beverage can contents. At this point the needle N, the dispensing member or syringe S and the infusant are in fluid communication with the beverage once the needle N pierces the infusion port 28 at the area of reduced thickness, passes through the gate member 30 and the base member 32. Once the contents of the syringe is discharged using a plunger, in a known form, the needle N is withdrawn from the septum 22 and the septum is allowed to reseal so that the infusion port is completely sealed.

### ALTERNATE EMBODIMENTS

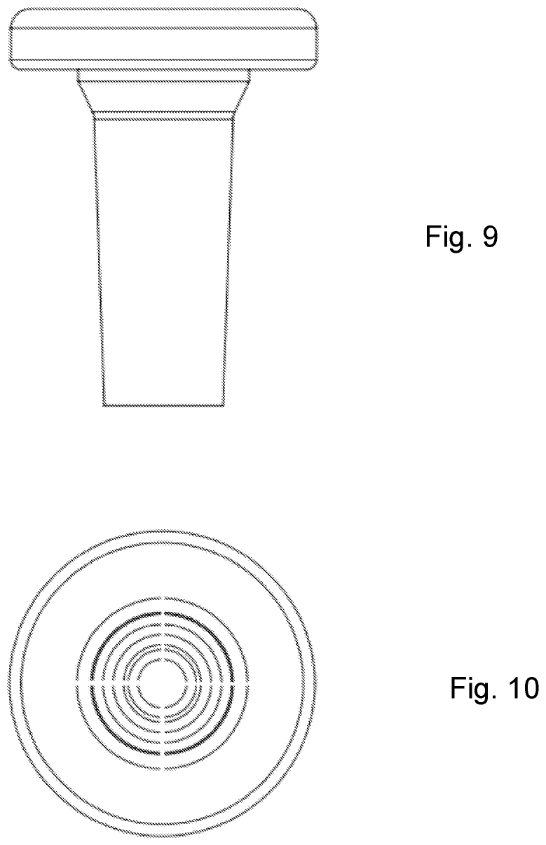

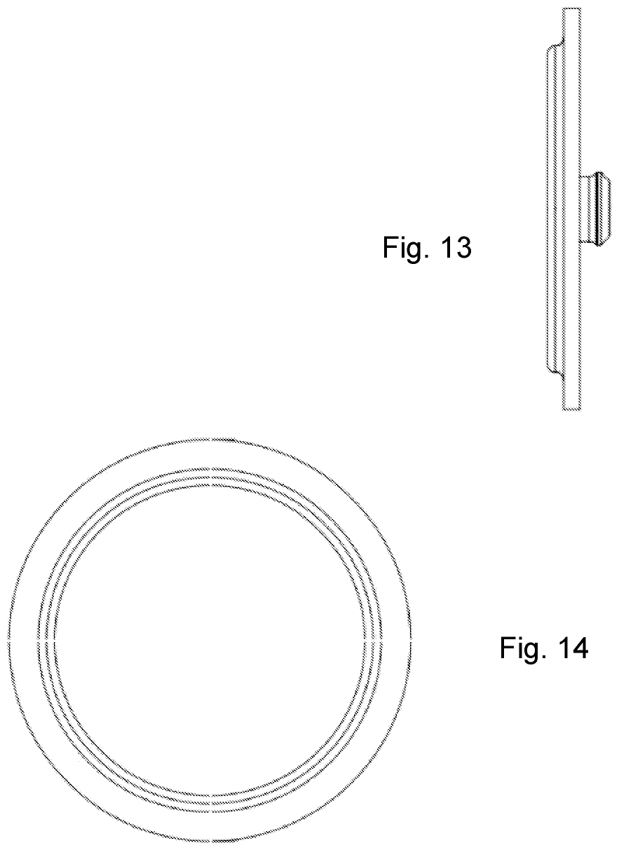

FIGS. 9-14 show alternate forms of the infusion septum herein described. FIGS. 9-10 show a pull-style infusion septum using a standard horizontal type injection molding machine and simple secondary insertion of the infusion port with a multi-cavity mold. The post molded parts are secondarily loaded onto the can end. The infusion septum shown in FIGS. 9 and 10 is inserted through the bottom portion or surface of the can lid by mechanically pulling the smaller end of the flexible infusion septum through the hole in the can end and snapping the upper portion, neck or pull port of the septum across an undercut near the base of the infusion port. The undercut is formed when the pull port is stretched into place. The outside diameter of the pull port is approximately 0.008 inches larger than the opening in the can that the port passes through. Once the pull port is pulled through the opening, a sealing occurs through the interference fit between the can opening edges and the pull port. If the beverage is carbonated, this aids further in applying pressure against the sealing surface. Preferably, any excess material is mechanically trimmed.

The preferable method in terms of sealing integrity is to insert the infusion port from the bottom of the can lid. This is done by mechanically “pulling” the smaller end of the flexible infusion septum through the hole in the can end and snapping the pull port across an undercut near the base of the infusion port which helps retain the part into a fixed position. The excess material from the “ear” is trimmed away leaving approximately 0.020″ standing proud above the top of the can end. Further, the pressure from the carbonated gas helps seat the infusion ports larger diameter against the bottom of the can end.

To infuse the beverage or liquid product, a needle is inserted inside the hollow portion of the pull port and the thermoplastic elastomer is pierced through the bottom or lower portion of the pull port structure and infusion material is introduced into the beverage or liquid. The needle is removed and the elastomer self-seals. Once the container has been infused and to assure an aseptic and tamperproof condition, an adhesive button or dome gel label is pressed over the pull port and sealed closed. The product is then ready for sale and transport to the customer. The uninfused cans which contain the beverage substrate are produced at preferably a copacker and the cans are then filled and the can end with the infusion port seamed onto the can unit.

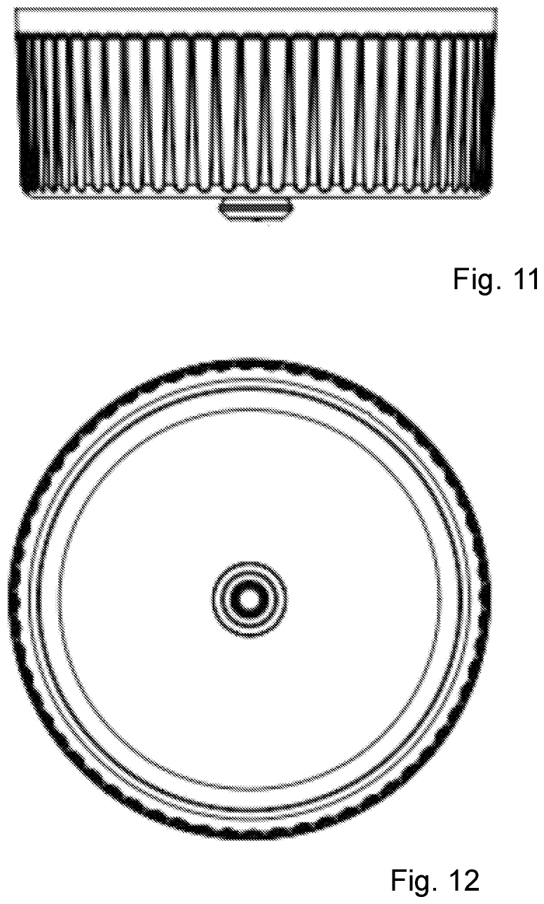

Another form of infusion septum is shown in FIGS. 11-14 for beverages or liquids that are noncarbonated and filled using a hot fill method as are many juices and sport drinks available with plastic bottling. This form has an integrated liner which is necessary for a proper airtight seal. The liner is preferably a removable silver disk. As with the pull port, this entire piece is injection molded using the same thermoplastic elastomer which has the ability to withstand the 160 degrees F. required in the hot fill operation. The insertion of this device is with a mechanical press. The front or top hollow portion of the port has a lead in angle which allows for proper alignment and the port is then pressed in and retained by an undercut on the top portion of the infusion port. Infusion occurs in the same manner where a needle is inserted in the hollow tube, the elastomer membrane is pierced and the infusion material is added to the beverage or liquid. To assure an aseptic seal and tamper evidence, the same adhesive button or label is pressed over the infusion port.

While the present methods and forms have been described in connection with the illustrated embodiments, it will be appreciated and understood that modifications may be made without departing, from the true spirit and scope.

I claim:

1. A beverage container can end having an integrated infusion port, comprising:
a standard tab assembly for non-resealable opening of said beverage container can end;
an infusion port opening located near a periphery of an edge of said can end;
an integrated infusion port having an upper collar, a location port, a gate member and a base member; and
said infusion port centered over said infusion port opening.

2. The infusion port of claim 1 wherein said gate member links said upper collar and said base member through said infusion port opening.

3. The infusion port of claim 1 wherein said infusion port is resealable.

4. The infusion port of claim 1 wherein said infusion port is made up of a resilient elastomer.

5. The infusion port of claim 1 wherein said base member includes a tab member.

6. The infusion port of claim 1 wherein said location port is of lesser thickness than said upper collar.

7. A beverage container sealing end having an integrated infusion port, comprising:
a standard sealing end of said beverage container can end;
an infusion septum within said sealing end, said septum having an integrated port passing through said sealing end;
said integrated port sealed within said sealing end with an interference fit;
said integrated port having a port opening with an upper collar, an infusion port and a lower base member; and
said infusion port centered over said port opening.

8. A method of infusing a pre-filled beverage container using an integrated infusion port, the steps comprising:
providing a modified beverage can end with an integrated self-sealing infusion port;
securing said modified can end to said pre-filled beverage container;
inserting a piercing member into said self-sealing infusion port, said piercing member in fluid communication with a dispensing member containing an infusant;
passing said piercing member through said infusion port into an interior of said beverage container;
injecting said infusant from said dispending member into said container;
intermixing said infusant with said beverage contained within said beverage container;
withdrawing said piercing member for self-sealing of said infusion port; and
sealing said infusion port with an adhesive member.
